(19) United States
(12) Patent Application Publication
(10) Pub. No.: US 2018/0280840 A1
(43) Pub. Date: Oct. 4, 2018

(54) Method and Device for Separating Solids and Liquids using a Modified Pump

(71) Applicants: Larry Baxter, Orem, UT (US); David Frankman, Provo, UT (US); Aaron Sayre, Spanish Fork, UT (US); Nathan Davis, Bountiful, UT (US)

(72) Inventors: Larry Baxter, Orem, UT (US); David Frankman, Provo, UT (US); Aaron Sayre, Spanish Fork, UT (US); Nathan Davis, Bountiful, UT (US)

(21) Appl. No.: 15/472,584

(22) Filed: Mar. 29, 2017

(51) Int. Cl. B01D 29/90; B01D 35/26; B01D 29/01; F04B 15/02; F04B 53/16; F04B 43/12; F04C 2/08; F04C 2/16; F04C 2/344; F04D 29/24

(52) U.S. Cl. CPC B01D 29/902; B01D 35/26; B01D 29/014; F04B 15/02; F04D 29/247; F04B 43/1253; F04C 2/084; F04C 2/16; F04C 2/344; F04B 53/16

(57) ABSTRACT

A device and a method for thickening a slurry are disclosed. A pump is provided comprising an inner chamber, a pumping apparatus, an external wall, an inlet, and an outlet. The slurry comprises a solid and a liquid. The slurry enters the inner chamber through the inlet and is pumped and pressurized by the pumping apparatus through the inner chamber across a portion of the external wall comprising a porous wall, causing a portion of the liquid to be pressed through the porous wall as a liquid product stream and thickening the slurry into a thickened slurry stream. The thickened slurry stream leaves through the slurry outlet.

This invention was made with government support under DE-FE0028697 awarded by The Department of Energy. The government has certain rights in the invention.

### FIELD OF THE INVENTION

This invention relates generally to solid/liquid separation. More particularly, we are interested in removing solids from liquids inside of pumps.

### BACKGROUND

Removing solids from liquids is a unit operation common to almost all heavy industries. Whether the process requires the removal of biomass and dirt from water, solid carbon dioxide from a cryogenic liquid, or dust from oil, solid/liquid separation is a constant. Filter presses, thickeners, clarifiers, and other devices all separate solids. However, these units all require pumps to feed the slurry to them, either directly or indirectly. The ability to thicken a slurry directly inside of a pump is not known in industry and would help eliminate costly capital equipment and reduce maintenance costs associated with a multiplicity of equipment.

U.S. Pat. No. 4,799,869, to Cordiano et al., teaches a pneumatic vane pump with oil separation. The pneumatic vane pump, run intermittently, has a cylindrical seat for its rotor constituted by a ring of porous sintered material housed in an outer container. The lubricating oil passes between the outer space and the ring when operating and reverses when not running. The present disclosure differs from this disclosure in that the vane pump is pumping air, not slurry, and the porous walls are entirely for passing lubricating oil back and forth, not for removing liquid from a slurry. This disclosure is pertinent and may benefit from the devices disclosed herein and is hereby incorporated for reference in its entirety for all that it teaches.

U.S. Pat. No. 3,290,864, to Harker, et al., teaches a gas separation pump for liquid circulating systems. The pump is utilized in hot water heating systems to remove gases released from the circulating liquid. The present disclosure differs from this disclosure in that the gas separation pump separates gases from liquids, not liquids from slurries. This disclosure is pertinent and may benefit from the devices disclosed herein and is hereby incorporated for reference in its entirety for all that it teaches.

U.S. Pat. No. 5,900,159, to Engel, et al., teaches a method for separating liquid from a slurry. The slurry is degasified through a cross-flow filter and separated into a liquid and concentrated slurry. The present disclosure differs from this disclosure in that the pump is used only for transporting the slurry to the filter, and is not the filter itself. This disclosure is pertinent and may benefit from the devices disclosed herein and is hereby incorporated for reference in its entirety for all that it teaches.

### SUMMARY

A device and a method for thickening a slurry are disclosed. A pump is provided comprising an inner chamber, a pumping apparatus, an external wall, an inlet, and an outlet. The slurry comprises a solid and a liquid. The slurry enters the inner chamber through the inlet and is pumped and pressurized by the pumping apparatus through the inner chamber across a portion of the external wall comprising a porous wall, causing a portion of the liquid to be pressed through the porous wall as a liquid product stream and thickening the slurry into a thickened slurry stream. The thickened slurry stream leaves through the slurry outlet.

The solid may comprise minerals, soot, biomass, frozen mercury, salts, water ice, hydrocarbons with a freezing point above a temperature of the liquid, solid particles, frozen acid gases, or combinations thereof, wherein acid gases comprise carbon dioxide, nitrogen oxide, sulfur dioxide, nitrogen dioxide, sulfur trioxide, hydrogen sulfide, hydrogen cyanide, or combinations thereof. The liquid may comprise any compound or mixture of compounds with a freezing point above a temperature at which the solid solidifies. The thickened slurry may comprise a paste.

The porous wall may comprise an opening or openings that may be smaller than a smallest particle of the solid. Vacuum may be provided to an exterior portion of the porous wall. The porous wall may comprise a material that inhibits adsorption of gases, prevents deposition of solids, or a combination thereof. The material may comprise ceramics, polytetrafluoroethylene, polychlorotrifluoroethylene, natural diamond, man-made diamond, chemical-vapor deposition diamond, polycrystalline diamond, or combinations thereof.

The pump may comprise a vane, flexible-impeller, gear, peristaltic, screw, double-screw, progressive-cavity, or piston pump. The porous wall may have any of the solid continuously removed by passage of a vane, impeller, gear, screw, or piston along the porous wall.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a method for thickening a slurry.

FIG. 2 shows a cross-sectional view of a vane pump for thickening a slurry.

FIG. 3 shows a cross-sectional view of a vane pump for thickening a slurry.

FIG. 4 shows a cross-sectional view of a balanced vane pump for thickening a slurry.

FIGS. 5A-C shows cross-sectional views of a piston pump for thickening a slurry.

FIG. 6 shows an isometric cutaway view of a screw pump for thickening slurry.

FIG. 7 shows a cross-sectional view of a gear pump for thickening slurry.

FIG. 8 shows a cross-sectional view of a peristaltic pump for thickening slurry.

FIG. 9 shows a cross-sectional view of a progressive-cavity pump for thickening slurry.

FIG. 10 shows a cross-sectional view of a flexible vane filter for thickening a slurry.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

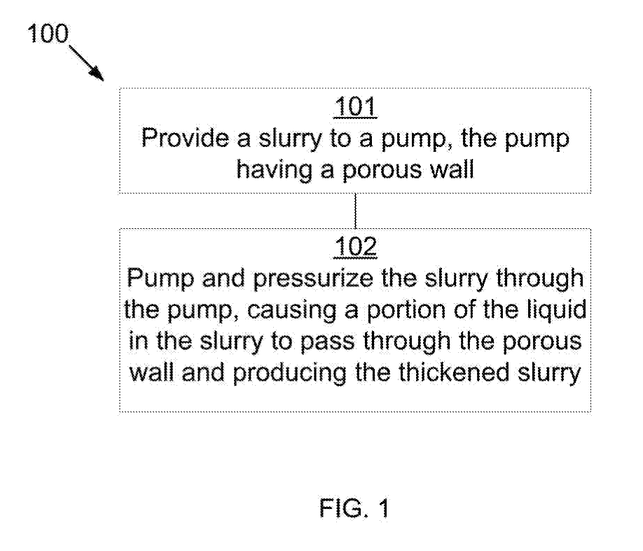

Referring to FIG. 1, a method for thickening a slurry is shown at 100, as per one embodiment of the present invention. The slurry is provided to a pump, the pump comprising a porous wall 101. The slurry comprises a solid and a liquid. The slurry is pumped and pressurized through the pump across the porous wall, causing a portion of the liquid to be pressed through the porous wall as a liquid product stream and thickening the slurry into a thickened slurry stream 102. In this manner, the slurry is thickened.

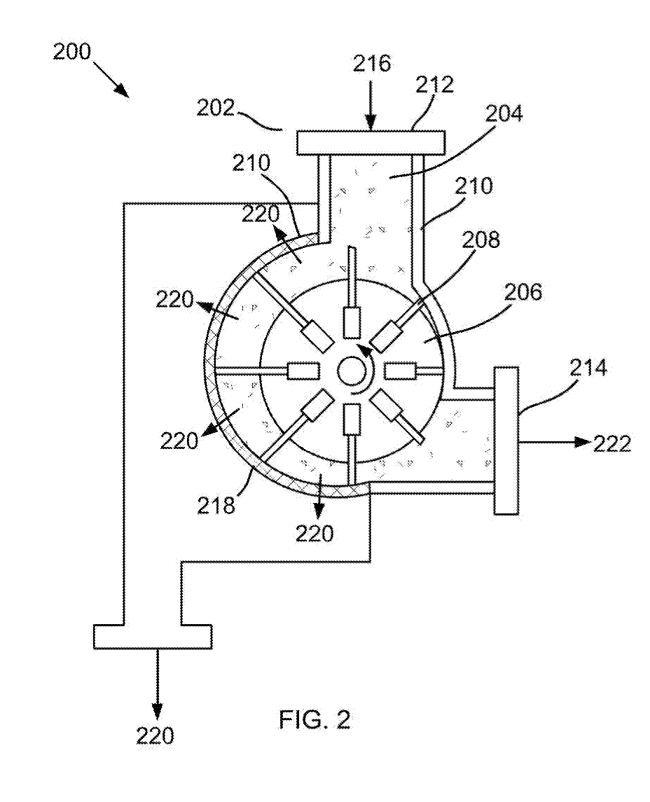

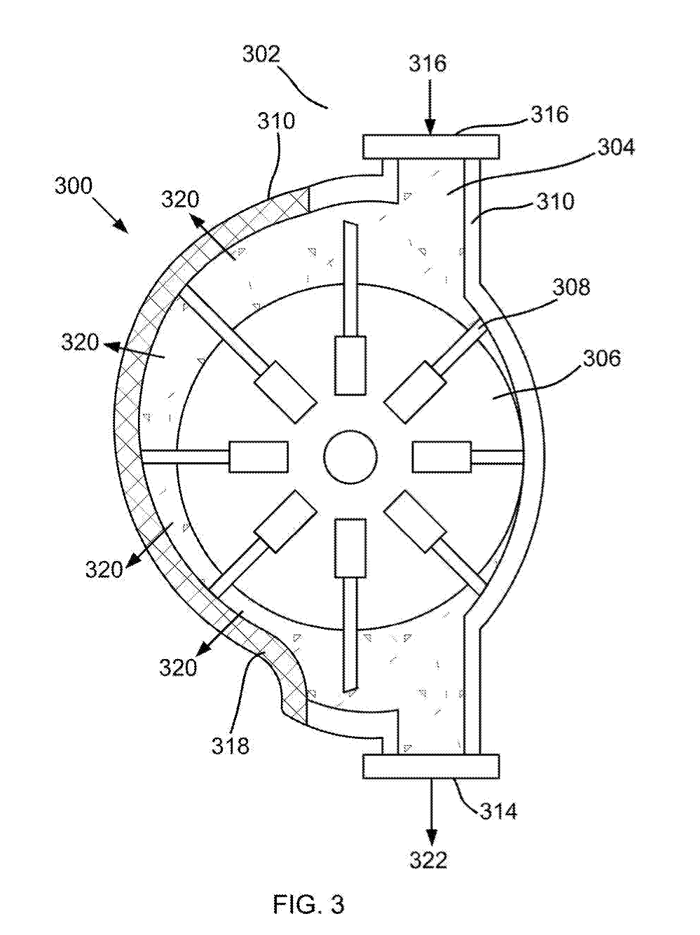

FIG. 2 shows a cross-sectional view of a vane pump for thickening a slurry at 200, as per one embodiment of the present invention. Vane pump 202 comprises inner chamber 204, rotor 206, vanes 208, external wall 210, inlet 212, and outlet 214. Slurry 216 is provided through inlet 212 to inner chamber 204. Slurry 216, comprising a liquid and a solid, is pumped and pressurized through inner chamber 204 across a portion of external wall 210, the portion comprising porous wall 218, by the pumping apparatus, comprising vanes 208 turned by rotor 206. This causes a portion of the liquid to be pressed across porous wall 218 as liquid product 220. The removal of the liquid causes slurry 216 to be thickened to thickened slurry 222. Thickened slurry 222 leaves vane pump 202 through outlet 214. Vanes 208 provide a self-cleaning advantage to vane pump 202 for thickening, as any solids that build up on porous wall 218 are scraped off by vanes 208 as they pass across the surface. In some embodiments, thickened slurry 222 has sufficient liquid removed to become a paste.

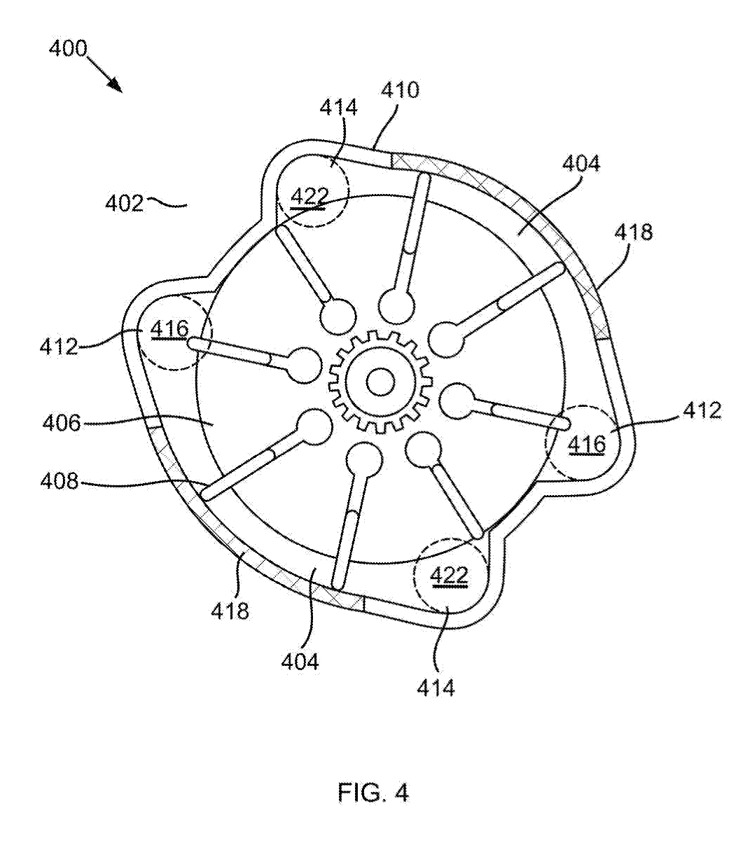

FIG. 3 shows a cross-sectional view of a vane pump for thickening a slurry at 300, as per one embodiment of the present invention. Vane pump 302 comprises inner chamber 304, rotor 306, vanes 308, external wall 310, inlet 312, and outlet 314. Slurry 316 is provided through inlet 312 to inner chamber 304. Slurry 316, comprising a liquid and a solid, is pumped and pressurized through inner chamber 304 across a portion of external wall 310, the portion comprising porous wall 318, by the pumping apparatus, comprising vanes 308 turned by rotor 306. This causes a portion of the liquid to be pressed across porous wall 318 as liquid product 320. The removal of the liquid causes slurry 316 to be thickened to thickened slurry 322. Thickened slurry 322 leaves vane pump 302 through outlet 314. Vanes 308 provide a self-cleaning advantage to vane pump 302 for thickening, as any solids that build up on porous wall 318 are scraped off by vanes 308 as they pass across the surface. In some embodiments, thickened slurry 322 has sufficient liquid removed to become a paste.

FIG. 4 shows a cross-sectional view of a balanced vane pump for thickening a slurry at 400, as per one embodiment of the present invention. Balanced vane pump 402 comprises inner chambers 404, rotor 406, vanes 408, external wall 410, inlets 412, and outlets 414. Slurry 416 is provided through inlets 412 to inner chambers 404. Slurry 416, comprising a liquid and a solid, is pumped and pressurized through inner chambers 404 across two portions of external wall 410, the portions comprising porous walls 418, by the pumping apparatus, comprising vanes 408 turned by rotor 406. This causes a portion of the liquid to be pressed across porous walls 418 as liquid product 420. The removal of the liquid causes slurry 416 to be thickened to thickened slurry 422. Thickened slurry 422 leaves balanced vane pump 402 through outlets 414. Vanes 408 provide a self-cleaning advantage to balanced vane pump 402 for thickening, as any solids that build up on porous walls 418 are scraped off by vanes 408 as they pass across the surface. In some embodiments, thickened slurry 422 has sufficient liquid removed to become a paste.

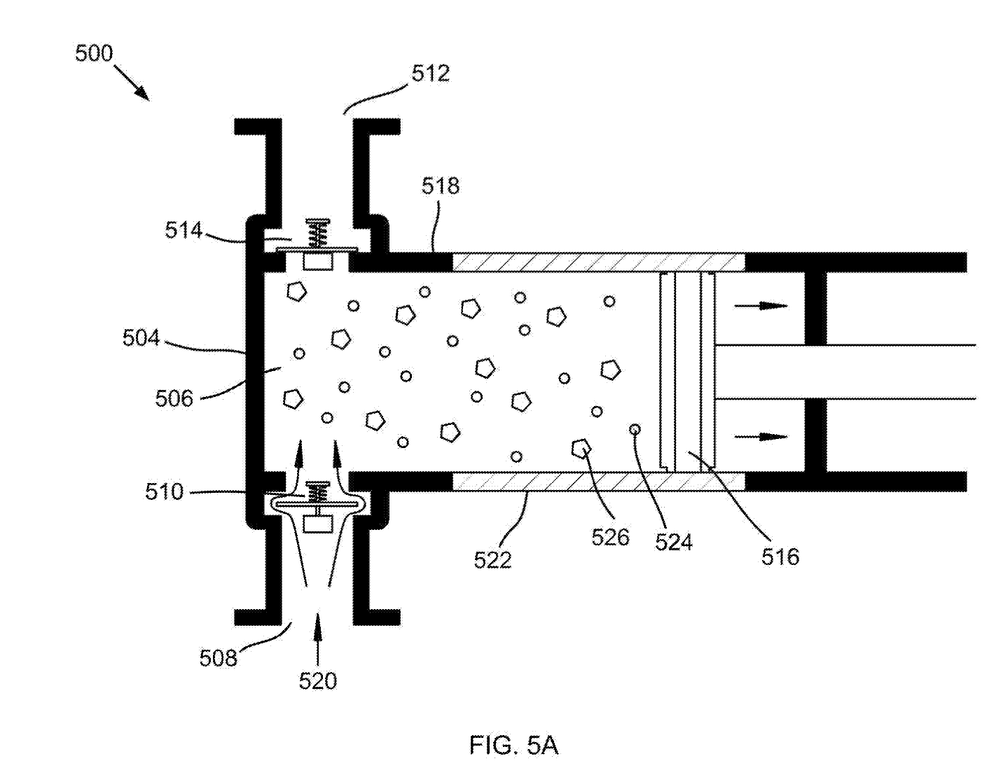

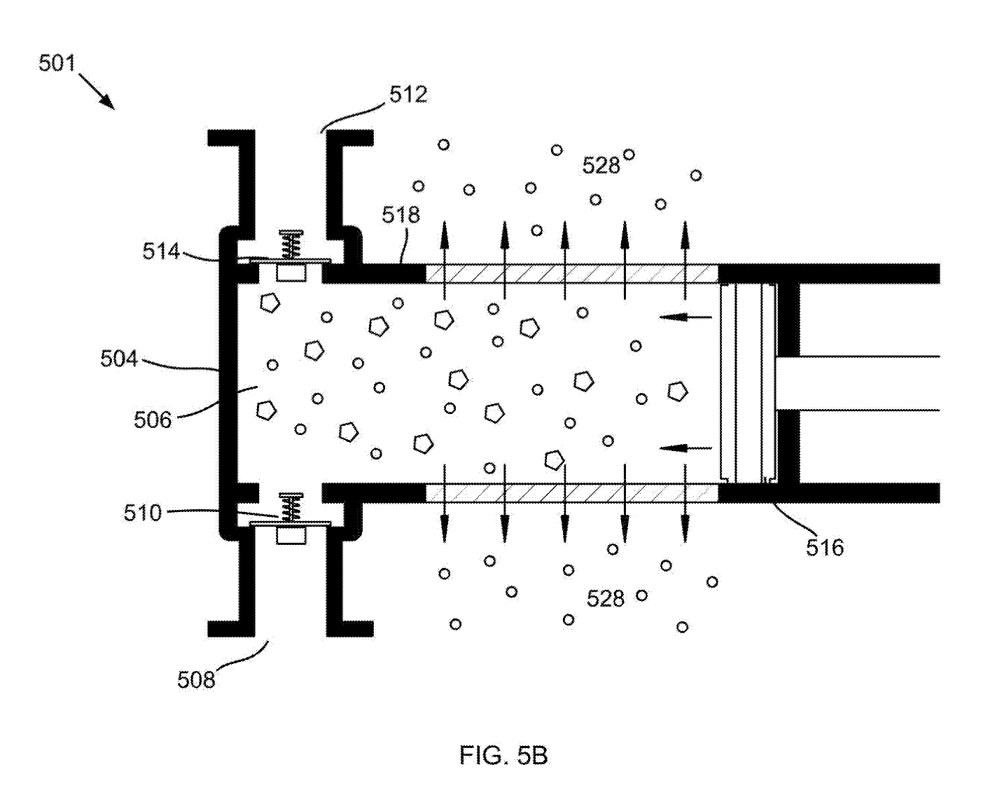

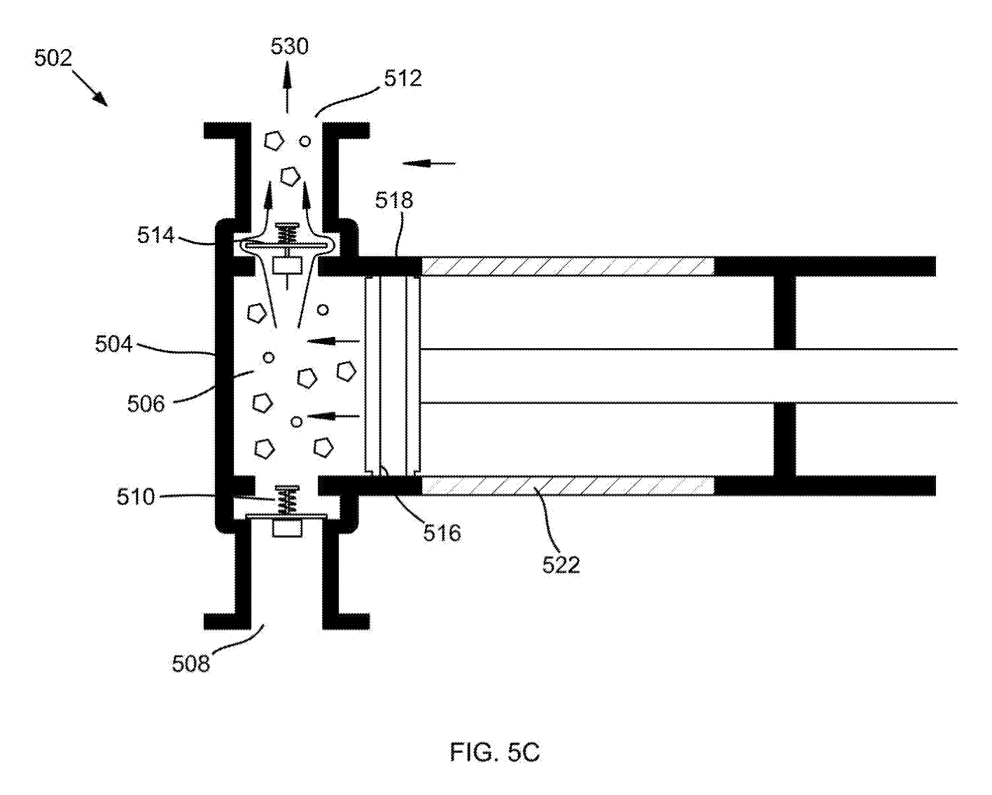

FIGS. 5A-C shows cross-sectional views of a piston pump for thickening a slurry, during intake at 500, during thickening at 501, and during removal at 502, as per one embodiment of the present invention. Piston pump 504 comprises inner chamber 506, inlet 508, inlet valve 510, outlet 512, outlet valve 514, plunger 516, and external wall 518. Slurry 520, comprising liquid 524 and solid 526, is drawn through inlet 508 past open inlet valve 510 by suction from plunger 516 being drawn back. Inlet valve 510 is closed and plunger 516 is pushed forward into inner chamber 506, pressing a portion of liquid 524 across porous wall 522 as liquid product 528, resulting in thickened slurry 530 inside of inner chamber 506. Outlet valve 514 is opened and plunger 516 continues into inner chamber 506, pushing a portion of thickened slurry 530 past outlet valve 514 and through outlet 512. The cycle is then repeated. Plunger 516 provides a self-cleaning advantage to piston pump 504 for thickening, as any solids 526 that build up on porous wall 522 are scraped off by plunger 516 as they pass across the surface. Further, as plunger 516 pushes into and out of inner chamber 506, a vacuum is provided on the inner chamber side of the porous wall, clearing solids 526 from openings in porous wall 522.

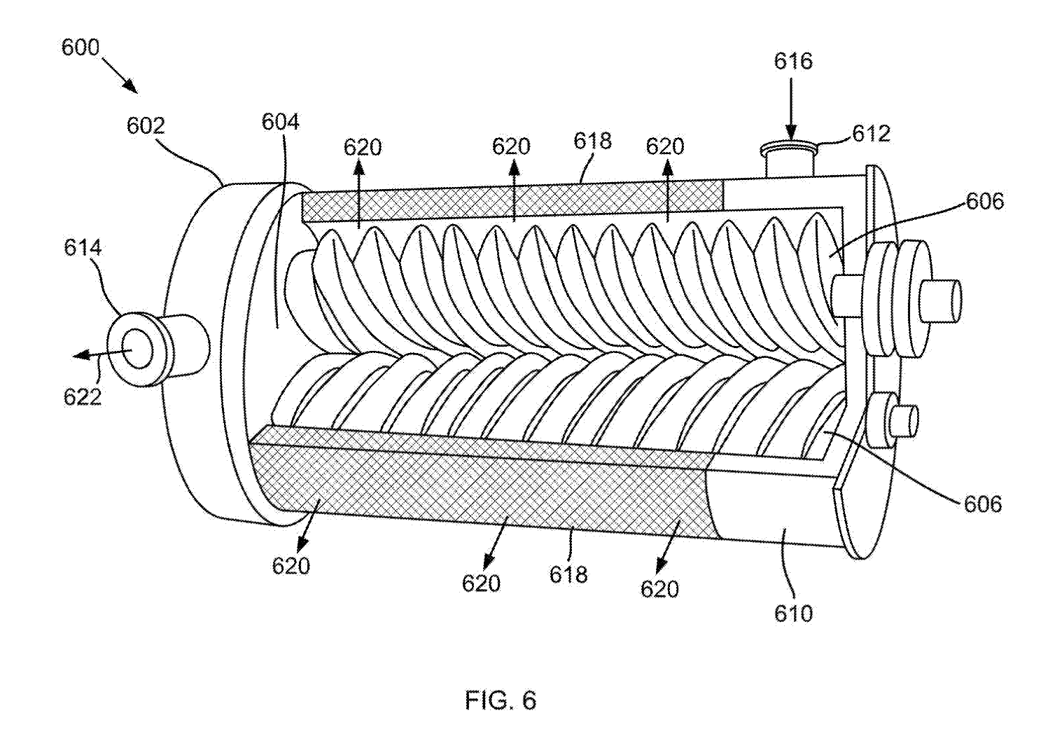

FIG. 6 shows an isometric cutaway view of a screw pump for thickening slurry at 600, as per one embodiment of the present invention. Screw pump 602 comprises inner chamber 604, screws 606, external wall 610, inlet 612, and outlet 614. Slurry 616 is provided through inlet 612 to inner chamber 604. Slurry 616, comprising a liquid and a solid, is pumped and pressurized through inner chamber 604 across a portion of external wall 610, the portion comprising porous wall 618, by the pumping apparatus, comprising screws 606. Screws 606 narrow between the inlet and the outlet, resulting in less volume for the slurry, pressurizing slurry 616, causing a portion of the liquid to be pressed across porous wall 618 as liquid product 620. The removal of the liquid causes slurry 616 to be thickened to thickened slurry 622. Thickened slurry 622 leaves screw pump 602 through outlet 614. Screws 606 provide a self-cleaning advantage to screw pump 602 for thickening, as any solids that build up on porous wall 618 are scraped off by screws 606 as they pass across the surface. In some embodiments, thickened slurry 622 has sufficient liquid removed to become a paste.

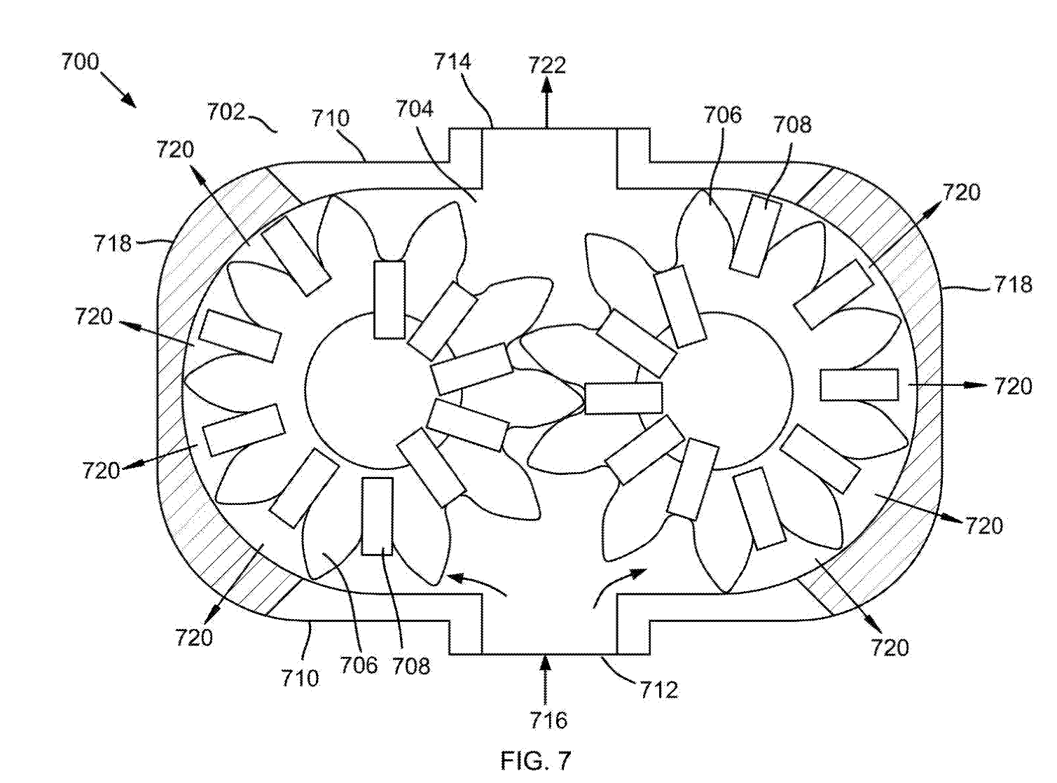

FIG. 7 shows a cross-sectional view of a gear pump for thickening slurry at 700, as per one embodiment of the present invention. Gear pump 702 comprises inner chamber 704, gears 706, bars 708, external wall 710, inlet 712, and outlet 714. Slurry 716 is provided through inlet 712 to inner chamber 704. Slurry 716, comprising a liquid and a solid, is pumped through inner chamber 704 across a portion of external wall 710, the portion comprising porous walls 718, by the pumping apparatus, comprising gears 706. Bars 708 extend from gears 706 when they are facing porous wall 718, resulting in less volume for the slurry, pressurizing slurry 716, causing a portion of the liquid to be pressed across porous wall 718 as liquid product 720. The removal of the liquid causes slurry 716 to be thickened to thickened slurry 722. Thickened slurry 722 leaves screw pump 702 through outlet 714. Gears 706 provide a self-cleaning advantage to gear pump 702 for thickening, as any solids that build up on porous wall 718 are scraped off by gears 706 as they pass across the surface. In some embodiments, thickened slurry 722 has sufficient liquid removed to become a paste. In some embodiments, inlet 712 and outlet 714 are switched, while gears 706 move in opposite directions.

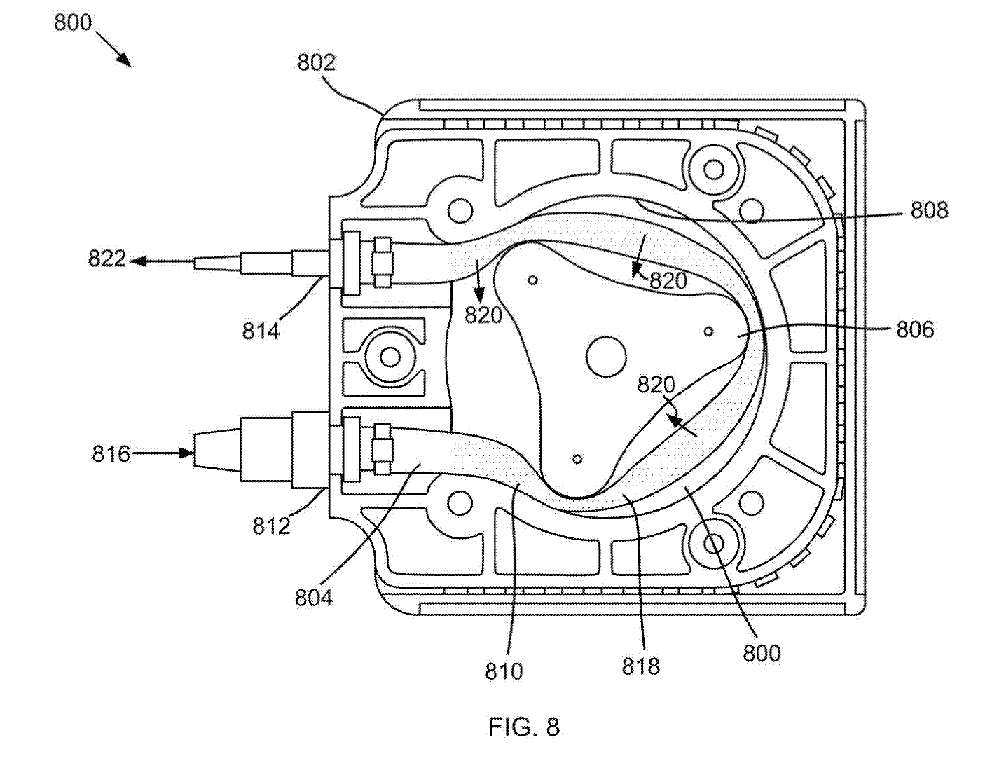

FIG. 8 shows a cross-sectional view of a peristaltic pump for thickening slurry at 800, as per one embodiment of the present invention. Peristaltic pump 802 comprises inner chamber 804, rotor 806, outer walls 808, hose 810, inlet 812, and outlet 814. Slurry 816 is provided through inlet 812 to inner chamber 804, inner chamber 804 being the inside of hose 810. Slurry 816, comprising a liquid and a solid, is pumped and pressurized through inner chamber 804 across a portion of hose 810, the portion comprising porous walls 818, by the pumping apparatus, comprising rotor 806. Outlet 814 is smaller than inlet 816, causing a restriction in hose 810, causing a portion of the liquid to be pressed across porous wall 818 as liquid product 820. The removal of the liquid causes slurry 816 to be thickened to thickened slurry 822. Thickened slurry 822 leaves peristaltic pump 802 through outlet 814. In some embodiments, hose 810 gradually becomes smaller between inlet 812 and outlet 814, increasing liquid removal.

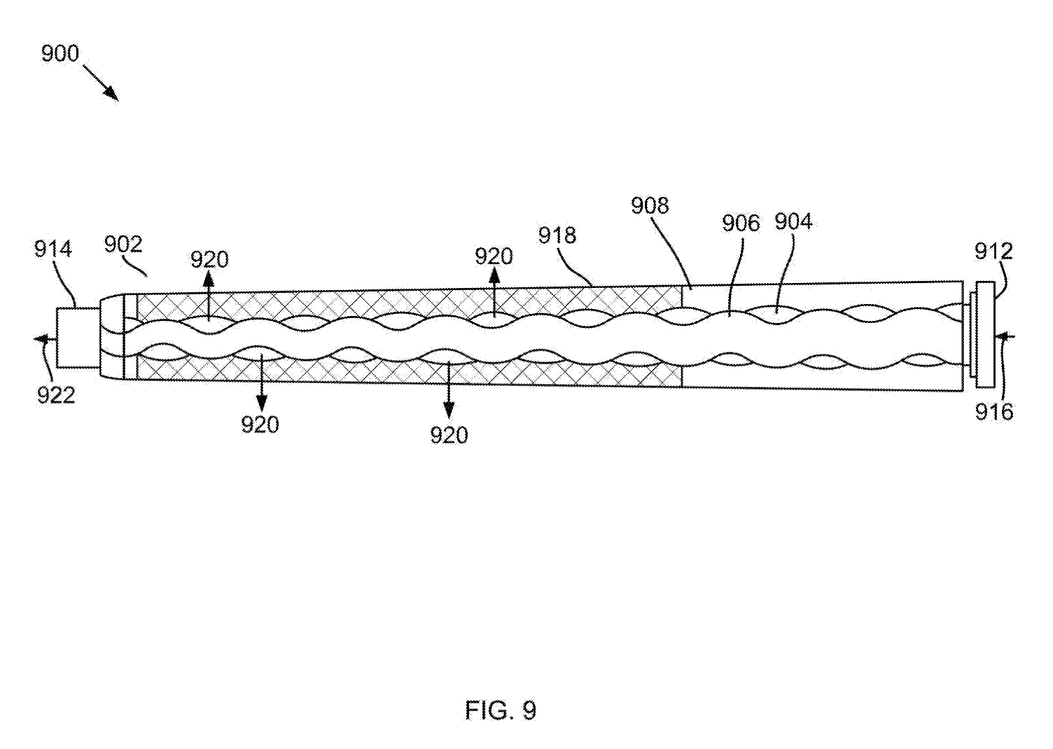

FIG. 9 shows a cross-sectional view of a progressive cavity pump for thickening slurry at 900, as per one embodiment of the present invention. Progressive cavity pump 902 comprises inner chamber 904, rotor 906, external walls 908, inlet 912, and outlet 914. Slurry 916 is provided through inlet 912 to inner chamber 904. Slurry 916, comprising a liquid and a solid, is pumped and pressurized through inner chamber 904 across a portion of external walls 908, the portion comprising porous walls 918, by the pumping apparatus, comprising rotor 906. Inner chamber 904 decreases in size between inlet 912 and outlet 914, causing a portion of the liquid to be pressed across porous wall 918 as liquid product 920. The removal of the liquid causes slurry 916 to be thickened to thickened slurry 922. Thickened slurry 922 leaves progressive cavity pump 902 through outlet 914.

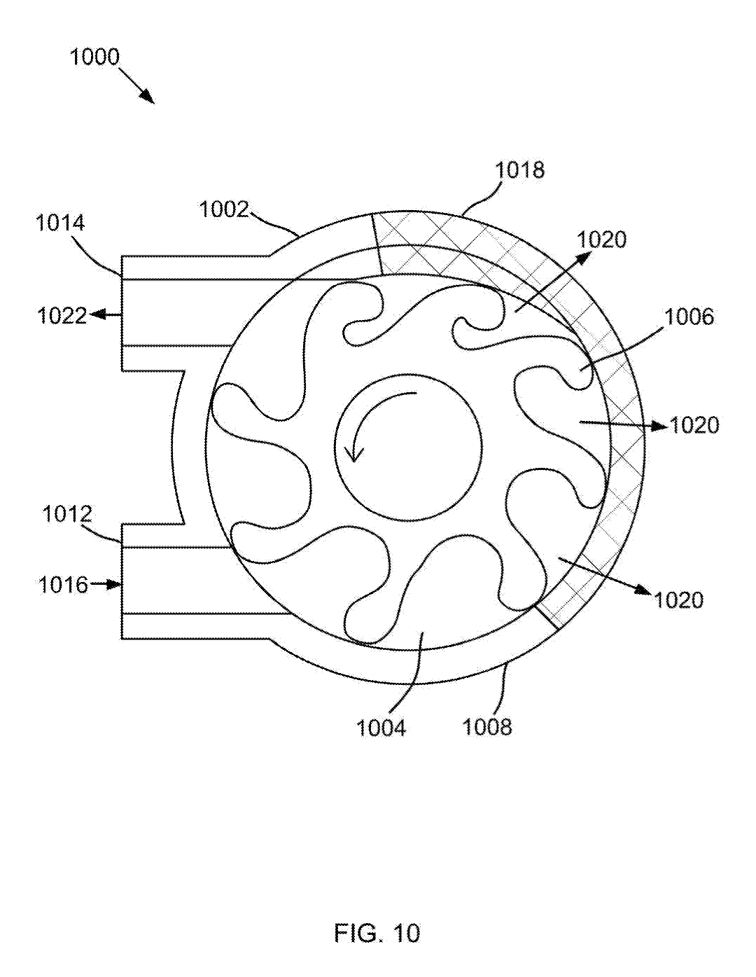

FIG. 10 shows a cross-sectional view of a flexible-impeller pump for thickening slurry at 1000, as per one embodiment of the present invention. Flexible-impeller pump 1002 comprises inner chamber 1004, flexible rotor 1006, external walls 1008, inlet 1012, and outlet 1014. Slurry 1016 is provided through inlet 1012 to inner chamber 1004. Slurry 1016, comprising a liquid and a solid, is pumped and pressurized through inner chamber 1004 across a portion of external wall 1008, the portion comprising porous walls 1018, by the pumping apparatus, comprising rotor 1006. Rotor 1006 is off center in inner chamber 1004, causing flexible rotor 1006 to form a restriction in inner chamber 1004, causing a portion of the liquid to be pressed across porous wall 1018 as liquid product 1020. The removal of the liquid causes slurry 1016 to be thickened to thickened slurry 1022. Thickened slurry 1022 leaves flexible-impeller pump 1002 through outlet 1014.

In some embodiments, the stators moving the rotor assembly are also movable.

In some embodiments, the porous wall comprises an opening or openings that are smaller than a smallest particle of the solid.

In some embodiments, the solid comprises minerals, soot, biomass, frozen mercury, salts, water ice, hydrocarbons with a freezing point above a temperature of the liquid, solid particles, frozen acid gases, or combinations thereof, wherein acid gases comprise carbon dioxide, nitrogen oxide, sulfur dioxide, nitrogen dioxide, sulfur trioxide, hydrogen sulfide, hydrogen cyanide, or combinations thereof. In some embodiments, the liquid comprises any compound or mixture of compounds with a freezing point above a temperature at which the solid solidifies.

In some embodiments, vacuum is provided to an exterior portion of the porous wall. In some embodiments, the porous wall comprises a material that inhibits adsorption of gases, prevents deposition of solids, or a combination thereof. In some embodiments, the material comprises ceramics, polytetrafluoroethylene, polychlorotrifluoroethylene, natural diamond, man-made diamond, chemical-vapor deposition diamond, polycrystalline diamond, or combinations thereof.

1. A method for thickening a slurry comprising:
providing the slurry to a pump, the pump comprising an inner chamber, a pumping apparatus, an external wall, an inlet, and an outlet, wherein:
the slurry comprises a solid and a liquid;
the slurry enters the inner chamber through the inlet and is pumped and pressurized by the pumping apparatus through the inner chamber across a portion of the external wall comprising a porous wall, causing a portion of the liquid to be pressed through the porous wall as a liquid product stream and thickening the slurry into a thickened slurry stream, the thickened slurry stream leaving through the slurry outlet;
whereby the slurry is thickened.

2. The method of claim 1, wherein the porous wall comprises an opening or openings that are smaller than a smallest particle of the solid.

3. The method of claim 1, wherein the solid comprises minerals, soot, biomass, frozen mercury, salts, water ice, hydrocarbons with a freezing point above a temperature of the liquid, solid particles, frozen acid gases, or combinations thereof, wherein acid gases comprise carbon dioxide, nitrogen oxide, sulfur dioxide, nitrogen dioxide, sulfur trioxide, hydrogen sulfide, hydrogen cyanide, or combinations thereof.

4. The method of claim 1, wherein the liquid comprises any compound or mixture of compounds with a freezing point above a temperature at which the solid solidifies.

5. The method of claim 1, wherein vacuum is provided to an exterior portion of the porous wall.

6. The method of claim 1, wherein the porous wall comprises a material that inhibits adsorption of gases, prevents deposition of solids, or a combination thereof.

7. The method of claim 6, wherein the material comprises ceramics, polytetrafluoroethylene, polychlorotrifluoroethylene, natural diamond, man-made diamond, chemical-vapor deposition diamond, polycrystalline diamond, or combinations thereof.

8-9. (canceled)

10. The method of claim 1, wherein the thickened slurry comprises a paste.

11. A device for thickening a slurry comprising:
a pump comprising an inner chamber, a pumping apparatus, an external wall, an inlet, and an outlet, wherein:
the slurry comprises a solid and a liquid;
the slurry enters the inner chamber through the inlet and is pumped and pressurized by the pumping apparatus through the inner chamber across a portion of the external wall comprising a porous wall, causing a portion of the liquid to be pressed through the porous wall as a liquid product stream and thickening the slurry into a thickened slurry stream, the thickened slurry stream leaving through the slurry outlet.

12. The device of claim 11, wherein the porous wall comprises an opening or openings that are smaller than a smallest particle of the solid.

13. The device of claim 11, wherein the solid comprises minerals, soot, biomass, frozen mercury, salts, water ice, hydrocarbons with a freezing point above a temperature of the liquid, solid particles, frozen acid gases, or combinations thereof, wherein acid gases comprise carbon dioxide, nitrogen oxide, sulfur dioxide, nitrogen dioxide, sulfur trioxide, hydrogen sulfide, hydrogen cyanide, or combinations thereof.

14. The device of claim 11, wherein the liquid comprises any compound or mixture of compounds with a freezing point above a temperature at which the solid solidifies.

15. The device of claim 11, wherein vacuum is provided to an exterior portion of the porous wall.

16. The device of claim 11, wherein the porous wall comprises a material that inhibits adsorption of gases, prevents deposition of solids, or a combination thereof.

17. The device of claim 16, wherein the material comprises ceramics, polytetrafluoroethylene, polychlorotrifluoroethylene, natural diamond, man-made diamond, chemical-vapor deposition diamond, polycrystalline diamond, or combinations thereof.

18-19. (canceled)

20. The device of claim 11, wherein the thickened slurry comprises a paste.

21. The method of claim 1, further comprising removing any of the solid that deposits on the porous wall.
